(19) United States
(12) Patent Application Publication
(10) Pub. No.: US 2026/0365072 A1
(43) Pub. Date: Nov. 19, 2026

(54) QR-CODE IDENTIFICATION BASED ELECTRIC VEHICLE CHARGING STATION SYSTEM FOR PRESENTATION OF CHARGING EVENT INFORMATION

(71) Applicant: Liikennevirta Oy / Virta Ltd, Helsinki (FI)

(72) Inventor: Jussi AHTIKARI, Helsinki (FI)

(73) Assignee: Liikennevirta Oy / Virta Ltd, Helsinki (FI)

(21) Appl. No.: 19/133,879

(22) PCT Filed: Nov. 28, 2023
(86) PCT No.: PCT/FI2023/050650

§ 371 Date: May 29, 2025

(30) Foreign Application Priority Data
Nov. 30, 2022 (FI) 20226063

(51) Int. Cl. B60L 53/68; B60L 53/30; B60L 53/66; B60L 53/67; G06Q 20/38; H04L 9/32

(52) U.S. Cl. CPC B60L 53/68; B60L 53/305; B60L 53/665; B60L 53/67; G06Q 20/38215; H04L 9/3263; B60L 2240/72; B60L 2250/16; H04L 2209/84

(57) ABSTRACT

According to an example embodiment, a device is configured to embody a charging station management system 100. The charging station management system 100 comprises a QR-code based charging station identification and data distribution system that allows a device with internet access and a web browser, access to view data related to a charging event of an electric vehicle 205 without any third-party mobile app. The charging station management system 100 may manage data exchange between multiple charging stations 203 and multiple screen devices 202 by handling the identification of each charging station 203 by storing the identification of each charging station 203 as a QRID 106. One QRID 106 may also comprise identifications of multiple charging stations 203, as access to the data of multiple charging stations 203 at the same time may be required in certain embodiments. The charging station management system 100 may comprise one or more processors 101 and one or more memories 102 that comprise computer program code 103. The device 100 may also comprise at least one communication interface 104, as well as other elements, such as an input/output module.

### TECHNICAL FIELD

The present disclosure generally relates to electric vehicle charging station site management. In particular, the present disclosure relates to a device, system, method and computer programs for managing and conveying status information of a charging station to a charging station end-user by utilizing a charging station management system.

### BACKGROUND

The background art considers an electric vehicle charging site managed by a charging station management system, CSMS, where the interface between the charging station, electric mobility provider, EMP, and the driver of an electric vehicle, EV, has been a mobile app. A driver generally registers as a customer of an EMP, when the need for using a charging station arises, and the EMP provides a mobile app. The mobile app provides information of available nearby stations, prices of using these stations, reservations, error messages etc.

Furthermore, the ISO15118 standard provides EV drivers the Plug & Charge technology, which enables automatic driver authorization when plugging in the charging cable from the EV to the station, all without the use of a mobile app.

Furthermore, physical payment terminals are also becoming more common in charging stations, which means the payment can be made directly with a debit/credit card without the requirement of a mobile app. The use of a physical payment terminal also minimizes the communication for example between the EMP and the driver, as the requirement for registering as a customer is no longer necessary.

Thus, the disappearance of an interface between the charging station, EMP and the driver of an EV creates a problem much like a conventional petrol station without any charging meter for filling up the tank.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

The disclosure herein provides a device, system, method and a computer program for a QR-code based charging station management system, CSMS, that can provide a driver or a charging site the means to convey information of a charging event on a device with internet connection and a web browser.

An example embodiment of a device for operating a CSMS comprises: at least one processor; and at least one memory including programmable logic, where the at least one memory and the programmable logic are configured, with the at least one processor, to cause the device to store at least one identification of a charging station, QRID, wherein the charging station associated with the QRID comprises a QR-code and wherein the QRID is associated with the QR-code. Additionally, the device is configured to receive a first request from a client device, where the first request comprises an authorization to receive further data from the client device and wherein the client device is a device capable of scanning the QR-code. Furthermore, the device is configured to generate the authorization, the authorization comprising code for the client device to generate a certificate. Furthermore, the device is configured to transmit the authorization back to the client device. Even furthermore, the device is configured to receive the certificate from the client device, the certificate comprising the QRID and an identification of a screen device. Even furthermore, based on the QRID, the device is configured to transmit a second request to the identified charging station connected to the device, and based on the second request, the device is configured to receive a first data from the charging station, the first data comprising information of the charging station. Finally, the device is configured to transmit a second data to the screen device identified in the certificate, the second data comprising at least a portion of the first data to be displayed on the screen device. For example the QRID-QR-code based identification of a charging station may grant any user with a device that has access to internet and a web browser, an easy way of displaying information related to the charging station, such as incorrectly plugged cable, or related to the charging station management system, such as reservations of charging station or service messages.

In an example embodiment, alternatively or in addition to the above-described example embodiment, the first data received by the device comprises information of an electric vehicle. This example embodiment may grant the user the access to display information related to the charging event, such as running cost of the current charging event, or the state of charge of the electric vehicle currently charging.

In an example embodiment, alternatively or in addition to the above-described example embodiments, the device is configured to receive data from the screen device. Such data may be an identification of the screen device. This example embodiment may allow the CSMS to identify and categorize the screen device that is connected to the system.

In an example embodiment, alternatively or in addition to the above-described example embodiments, the device further comprises a database and the device is further configured to receive the first data in regular or irregular intervals. Furthermore, the device is configured to transmit the second data in regular or irregular intervals and the database is configured to store the at least one QRID and obtain the first data from an API. This example embodiment may specify the data storing method of the CSMS, and how the administrator of the CSMS may configure the time intervals, how the data is exchanged between the devices.

In an example embodiment, alternatively or in addition to the above-described example embodiment that comprises the database, the device further comprises an infoscreen logic, wherein the infoscreen logic is configured to decide the contents of the second to be displayed on the screen device and to obtain at least a portion of the second data from the database. This example embodiment may specify how the data displayed on the screen device is filtered properly to improve the overall end-user experience, and how the data is obtained using the database.

In an example embodiment, alternatively or in addition to the above-described example embodiments that comprises i) the database and ii) the database and the infoscreen logic, the device comprises a web server, wherein the web server is configured to receive the first request from the client device. Furthermore, the web server is configured to transmit the authorization to the client device and receive the certificate from the client device. Finally, the web server is configured to transmit the second data. This example embodiment may specify the interface between the screen device, client device and the device, and allows the administrator of the CSMS to manage the data with more detail.

In an example embodiment, alternatively or in addition to the above-described example embodiments that comprises i) the database, ii) the database and the infoscreen logic and iii) the database, the infoscreen logic and the web server, the device comprises an application programming interface, API, wherein the API is configured to transmit the second request to the charging station and receive the first data. Furthermore, the API is configured to direct the first data to the database. This example embodiment may specify the interface between the device, the database and the charging station, granting detailed data management for the whole system.

In an example embodiment, alternatively or in addition to the above-described example embodiments, wherein the at least one QRID is associated with a plurality of charging stations, the plurality of charging stations comprising one QRID and the at least one QRID is associated with the one QR-code. This example embodiment may grant the device to associate one QRID for multiple charging stations, which allows the screen device to display data from multiple charging stations at the same time.

In an example embodiment, alternatively or in addition to the above-described example embodiments, the device is further configured to control a screen device group, wherein the screen device group comprises a first data link to at least one charging station associated with the QRID. Furthermore, the screen device group comprises a second data link to at least one screen device and finally, the screen device group comprises a third data link to the device. The screen device group is employed to manage a plurality of charging stations and screen devices. This example embodiment may grant the device an effortless way how to manage a plurality of devices exchanging data with the device.

An example embodiment of a system for displaying status information related to a charging operation of an electric vehicle comprises the example embodiments of the device described previously herein. Furthermore, the system comprises at least one screen device configured to receive the second data transmitted by the device. Finally, the system comprises at least one client device, wherein the client device is configured to i) scan a QR-code associated with at least one charging station, ii) transmit the first request to the device to obtain the authorization and iii) transmit a certificate to the device. This example embodiment of a system describes how the devices of all previously detailed embodiments may be utilized on a system level.

In an example embodiment of a system, alternatively or in addition to the above-described example embodiment, the screen device comprises at least a portion of the least one client device. This example embodiment may grant any user the possibility to use the same device for scanning the QR-code and displaying the information from the CSMS.

An example embodiment of a method for operating an electric vehicle charging station management system device comprises storing at least one identification of a charging station, QRID, wherein the charging station associated with the QRID comprises a QR-code and wherein the QRID is associated with the QR-code. Furthermore, the method comprises receiving a first request from a client device, wherein the first request comprises an authorization to receive further data from the client device and wherein the client device is a device capable of scanning the QR-code. Furthermore, the method comprises generating the authorization, the authorization comprising code for the client device to generate a certificate. Furthermore, the method comprises transmitting the authorization to the client device and receiving the certificate, wherein the certificate comprises the QRID and an identification of a screen device. Even furthermore, based on the QRID, the method comprises transmitting a second request to the identified charging station connected to the device and based on the second request, receiving a first data from the charging station, wherein the first data comprises information of the charging station. Finally, based on the first data and the certificate, the method comprises transmitting a second data to the screen device identified in the certificate, the second data comprising at least a portion of the first data to be displayed on the screen device.

In an example embodiment of a method, alternatively or in addition to the above-described example embodiment of a method, the method comprises receiving data from the screen device.

In an example embodiment of a method, alternatively or in addition to the above-described example embodiment of a method, the method comprises a screen device group, wherein the screen device group comprises a first data link to at least one charging station associated with the QRID and a second data link to at least one target screen device.

An example embodiment of a computer program product comprises program code configured to perform the method to any of the above example embodiments of methods, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 is a block diagram of an embodiment disclosed herein, illustrating a device (100) configured to operate an electric vehicle (205) charging station management system, CSMS. The at least one memory (102) comprises a memory block (105), wherein an identification of a charging station, CS (203), may be stored as form of a QRID (106).

FIG. 2 illustrates an example embodiment of the subject matter described herein illustrating the device (100) of FIG. 1 comprising a CSMS (100), wherein the CSMS is configured to manage an EV (205) charging site (299), wherein the charging site (299) comprises at least one charging station, CS (203). The figure illustrates the charging site as comprising three CS's, each CS comprising a QR-code (204) installed on-site. The embodiment requires the use of at least one client device (201) and at least one screen device (202), communicating, with the use of the QR-code, between the CSMS and CS(s). The client device may be the same device as the screen device.

FIG. 3 illustrates a more detailed example embodiment of the CSMS (100), where the CSMS comprises a database (300), an infoscreen logic (301), a web server (302) and an API (303).

FIG. 4 illustrates technical benefits of the QRID (106) and it's associated QR-code (204) system according to an embodiment, wherein the at least one QRID is associated with a plurality of charging stations (203).

FIG. 5 illustrates an example embodiment, where the CSMS (100) comprises a screen device group (400). The screen device group manages multiple charging stations (203) and multiple screen devices (202).

FIG. 6 illustrates an embodiment of default content data format displayed by a screen device (202), where four different charging stations (203) (identified by 100014-100017) are linked to the CSMS (100). The CSMS is transmitting status information of each station to the device, the screen device displaying the most important portion of the status information.

FIG. 7 illustrates another embodiment of the default content format, where a navigation map of the site is available and displayed on the screen device (202).

FIG. 8. illustrates the technical solution for displaying the default contents of FIGS. 6 and 7.

FIG. 9. illustrates the setup options of the screen device group illustrated in FIG. 5, or any embodiment, where multiple charging stations are associated with one QR-code.

FIG. 10 illustrates an embodiment of a screen device (202) displaying information from the CSMS (100) and charging station (203), where the information is related to starting a charging event.

FIG. 11 illustrates an embodiment of the technical solution for displaying information related to starting a charging event of FIG. 10.

FIG. 12 illustrates an embodiment of a screen device (202) displaying a state, where a charging event was rejected.

FIG. 13 illustrates the technical solution for displaying information related to rejection of the charging event of FIG. 12.

FIG. 14 illustrates an embodiment of a screen device (202) displaying a state, where a service message is assigned for each charging station (203).

FIG. 15 illustrates the technical solution for displaying the information related to service message state of FIG. 14.

FIG. 16 illustrates an embodiment of a screen device (202) displaying a state, where the charging event has ended.

FIG. 17 illustrates an embodiment of the technical solution for displaying the information related to the end of a charging event.

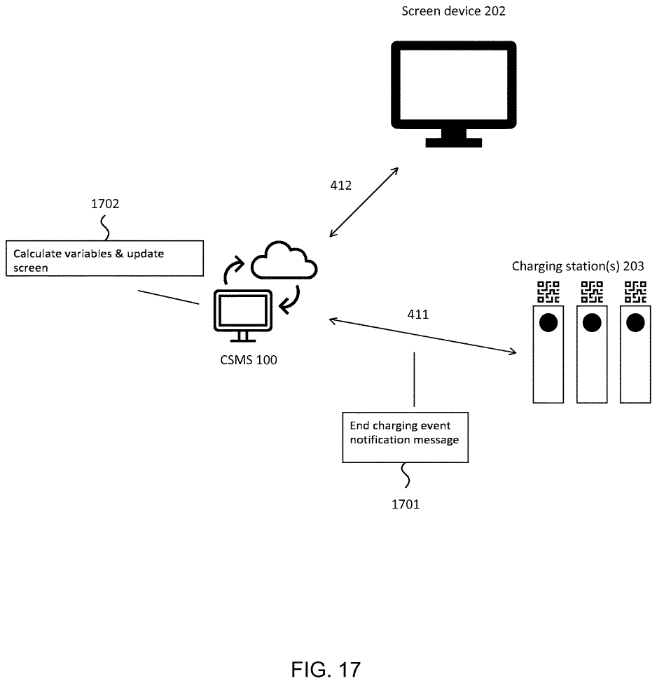

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

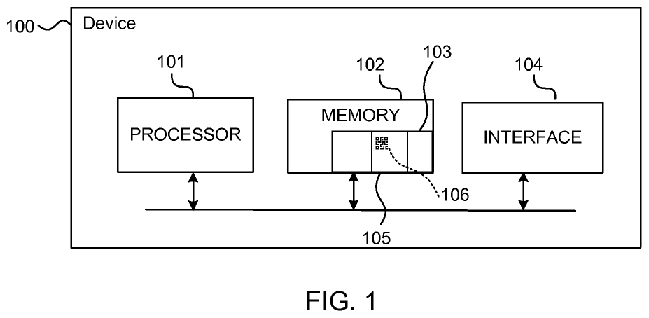

FIG. 1 is a block diagram of a device 100 configured as an embodiment disclosed herein, where the device 100 is configured to operate an electric vehicle, EV 205, charging station management system, CSMS 100. For the purposes of clarity, as the device is configured to operate the CSMS, they are both referred to with the numbering identification of ‘100’. The term “operate” here relates to several tasks, both unique and of general knowledge in the field. The device 100 may comprise one or more processors 101 and one or more memories 102 that may comprise computer program code 103. The device 100 may also comprise at least one communication interface 104, as well as other elements, such as input/output module (not shown in FIG. 1).

Although the device 100 is described and illustrated as having a single processor 101, the processor 101 may be embodied as a multi-core processor, a single core processor, or a combination of one or more multi-core processors and one or more single core processors. For example, the processor 101 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 101 may be configured to execute a hard-coded functionality. In an example embodiment, the processor 101 is embodied as an executor of software instructions, wherein the instructions may specifically configure the processor 101 to perform the algorithms and/or operations described herein when the instructions are executed.

The device 100 may be embodied in, for example, a computer. Alternatively, or in addition, the computer may be a cloud computer system having various distributed units.

The operations of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

The memory 102 may be embodied as one or more volatile memory devices, one or more non-volatile memory devices, and/or a combination of one or more volatile memory devices and non-volatile memory devices. For example, the memory 102 may be embodied as semiconductor memories (such as mask ROM, PROM (programmable ROM), EPROM (erasable PROM), flash ROM, RAM (random access memory), etc.).

The memory block 103 illustrates the memory required to carry out the functionality described herein. A block 105 of the memory block 103 illustrates a block of storing data for long term recurring use, i.e., a database 300. The central part of the disclosure herein requires the use of a QR-code 204 (not shown in FIG. 1) to be used in an EV 205 charging station 203 (not shown in FIG. 1), thus, in the memory block 105 at least one identification of a charging station 203, QRID 106, is stored, wherein each charging station, CS 203, associated with the QRID 106 comprises a QR-code 204 (also not shown in FIG. 1). The QRID 106 comprises at least a portion of the same data in binary/computer format as the QR-code 204 in physical, visual format. The QR-code 204 may be associated to one or more charging stations. The QR code may also be related to a charging site 299 (not shown in FIG. 1), and not necessarily only to a single charging station. For example, one site has a QR code, and that QR code is associated with information of one or more charging stations.

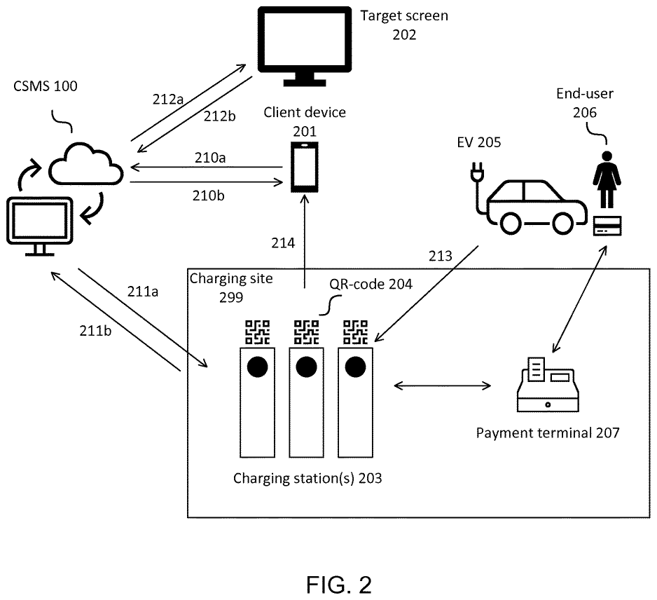

Referring to FIG. 2, the example task of the embodiment disclosed herein is to convey information of an EV 205, information of CS 203 and information of the CSMS 100 on any general screen device 202, the screen device 202 being any device with an internet connection and a web browser, such as a tablet or a smart phone. The information may be changing, dynamic information such as charging cost of the charging event or more static information such as an error message if the EV 205 is not plugged in. The application of the QR-code 204 removes the requirement to use an intermediate app between for example, an electric mobility provider, EMP, and the end-user 206. Any information configured by the administrator of the CMS 100 to be displayed on the screen device 202, may be accessed on a client device 201, as long as the client device 201 has the capability to scan a QR-code 204.

The screen device 202 may also comprise a plurality of devices, as the disclosure does not limit the amount of devices the previously mentioned status information of the CS 203, EV 205 or CSMS 100 may be transmitted to. The plurality of screen devices 202 is managed by a screen device group 400, the screen device group 400 described later in this chapter in more detail. Furthermore, the screen device 202 may be any device operated by an end-user 206 or it may be provided by a charging site 299 itself or previously installed on-site.

The functionality of the main task may be achieved with the QR-code 204, wherein each QR-code 204 may be generated by any method or device capable of generating a QR-code 204, such as the CSMS 100 itself. The generated QR-code 204 is unique to each CS 203, is installed on the charging site 299 and comprises at least an identification of the respective CS 203. As described earlier, the CSMS 100 itself comprises the respective identification of the CS 203 in the memory block 105 in the form of a QRID 106. By scanning the QR-code 204 with a client device 201, the CSMS 100 receives 210a a first request from the client device 201, wherein the first request comprises an authorization to receive further data from the client device 201. The CSMS 100 then generates the authorization, which comprises code for the client device 201 to generate a certificate. The CSMS 100 then transmits 210b the authorization to the client device 201 and receives 210a the certificate. The certificate comprises the QRID 106 of the respective CS 203 and the identification of a screen device 202. This is executed for the purpose transmitting 211a a second request of obtaining a first data from the CS 203 identified by the QRID 106 to the CSMS 100. The first data comprises of information of the CS 203 such as error messages or reservations. Furthermore, the CSMS 100 is configured to transmit second data 212a to the screen device 202 identified by the certificate, the second data comprising of at least a portion of the first data, however, the second data may comprise information related to the CSMS 100 itself. The first data may further comprise information related to the charging event of the EV 205 such as charging cost per kilowatt hour, kWh, or available charging power in kilowatts, kW.

In an additional embodiment of the disclosure, the EV 205, while plugged in to a CS 203, may transmit third data 213 to the CS 203, the third data 213 comprising information of the EV 205 and the third data is then added to the first data received 211b by the CSMS 100. The data may be i.e., state of charge, SoC, of the EV 205 or ISO15118 Plug & Charge standard information. The ISO15118 standard allows the storage of different EMP contracts in the EV 205, which may be accessed by the CS 203. The CSMS 100 is then configured to transmit 212a this EV 205 or ISO15118 Plug & Charge information to the screen device 202, provided the screen device 202 has established a link with the CS 203 through the CSMS 100, as previously detailed.

As with all digital devices and systems, the administrator of the CSMS 100 may choose a regular or an irregular interval during which the second data is transmitted 212a. The same interval may be applied to the first data link as well, but both can be chosen independently by the administrator, whichever suits the situation best.

While the payment may be made with a pre-existing Plug & Charge contract or pre-paid credit card, and the payment status is updated on the screen device 202 as described earlier. The disclosure does not limit the use of an external payment terminal 207 to be installed on the charging site 299. The payment could be made after the charging event and the data is then updated on the screen device 202 by the CSMS 100.

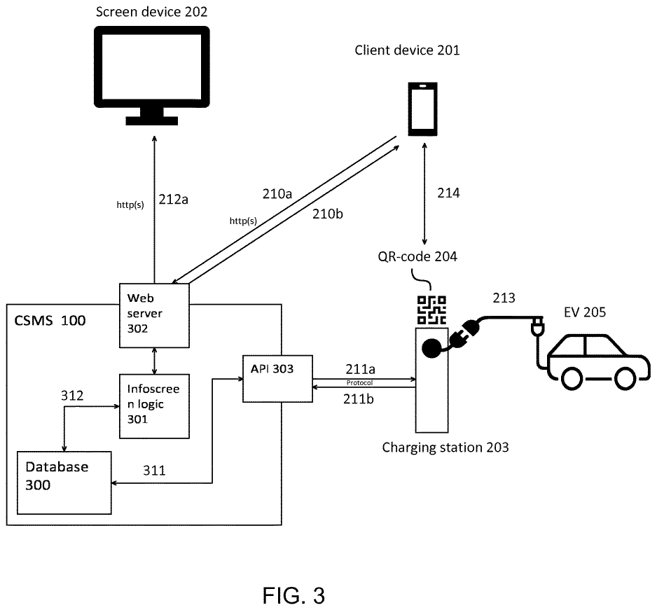

In additional embodiment of this disclosure as illustrated in FIG. 3, the CSMS 100 may comprise a database 300 where the previously mentioned device information, such as information of the CS 203 is stored. Furthermore, the screen device 202 may transmit 212b data to the CSMS 100, such as an identification, and the CSMS 100 may store this identification on the database 300. The CSMS 100 may check for updates to the database 300, which may be made by the administrator or the manufacturer and update the relevant data to the screen device 202. The data updated may be a service message or an error message.

Furthermore, as illustrated in FIG. 3, the CSMS 100 may comprise an infoscreen logic 301, wherein the infoscreen logic 301 is configured to decide the contents of the second data 312 transmitted 212a to the screen device 202 and obtain at least a portion of that second data from the database 300. The infoscreen logic 301 is employed to configure the format how the data will be displayed on the screen device 202 and make the end-user 206 experience much more satisfiable. The infoscreen logic 301 may be embodied i.e., as a code block in a cloud service or in the memory 102, or even an in an external or internal physical circuit that executes the described functionality.

Furthermore, as illustrated in FIG. 3, the CSMS 100 may comprise a web server 302, wherein the web server 302 is configured to receive 210a the first request to transmit 210b the authorization to the client device 201. Furthermore, the web server 302 is configured to receive the certificate from the client device 201 and finally transmit 212a the second data to the screen device 202. The web server is generally thought of as an interface between the internet and the CSMS 100 and it may be embodied in i.e., as a code block in cloud service or in the memory 102, a code block in the memory (102) or even in an external or internal physical circuit that executes the described functionality.

Furthermore, as illustrated in FIG. 3, the CSMS 100 may comprise an application programming interface, API 303, wherein the API 303 is configured to transmit 211a the second request to the CS 203 identified in the QRID 106, receive 211b the first data and direct that first data 311 to the database 300. The API may be embodied in i.e., as a code block in cloud service or in the memory 102, or even in an external or internal physical circuit that executes the described functionality. Employing the API 303 improves the management of the data flow.

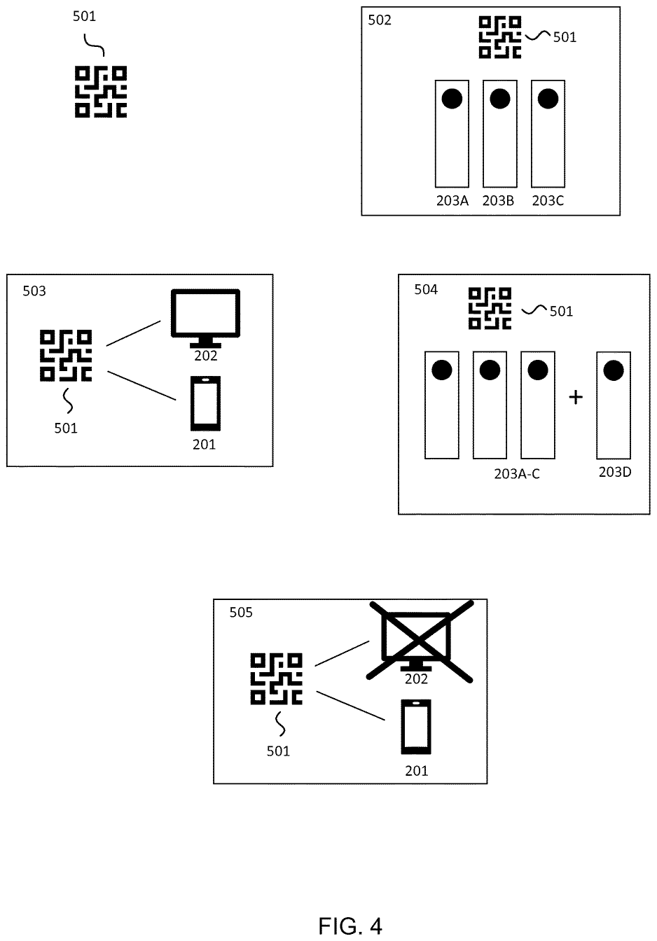

FIG. 4 illustrates an embodiment of the disclosure, wherein some technical benefits are described when one QRID is associated with multiple charging stations. At first in 501, a CSMS operator may print a large number of QR-codes 501 with associated QRID's 106, having an URL leading to a specific web site. The administrator of the charging site 299 does not need to know which CS's 203 are associated with one of the printed QR-code. When the charging site 299 is setup with CS's 203, the administrator of the CSMS 100 may link the one QR-code (from the plurality 501) and its associated QRID 106 to each CS 203A-C the administrator wants to be linked to a screen device 202 as is illustrated in 502. The administrator then may link the QRID 106 associated with the multiple CS's 203A-C to a screen device 202, i.e., a tablet device as illustrated in 503. This convenient setup allows the addition of any number of CS 203D to the initial CS group 203A-C as illustrated in 504. Should the screen device 202 be broken, as illustrated in 505, the administrator may just replace the broken screen device 202 with a new one.

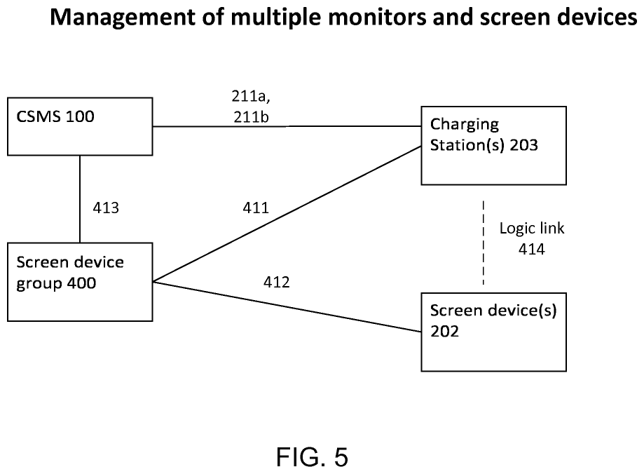

In FIG. 5, a block diagram of a system, where an embodiment of the CSMS 100 is used in conjunction with a screen device group 400, is illustrated. The screen device group 400 is employed to manage multiple CS's 203 and multiple screen devices 202 and it may be embodied as a code block i.e., as a code block in cloud service or in the memory 102, or even in an external or internal physical circuit that executes the functionality. The communication between the CMS 100, CS's 203 and the screen device group 400 is illustrated as data links 411-413 to clarify the visual representation. However, while the screen device group 400 may directly handle data exchange between the CS's 203 and screen devices 202, the first data link 411 to the CS's 203 and the second data link 412 to the screen devices 202 may be handled via the receive/transmit 211a/b-model of previous FIGS. 2 and 3. The third data link 413 is illustrated between the screen device group 400 and the CSMS 100 to exchange at least the QRID 106 data of the CS's 203 for the screen devices 202. This leaves multiple options for the administrator of the CSMS 100 to manage the multiple devices, i.e., by only adding the screen device group 400 to a pre-existing CSMS 100 with the third data link 413 and all exchange of data is handled through that third data link 413 and the screen device group only handles the processing of the data.

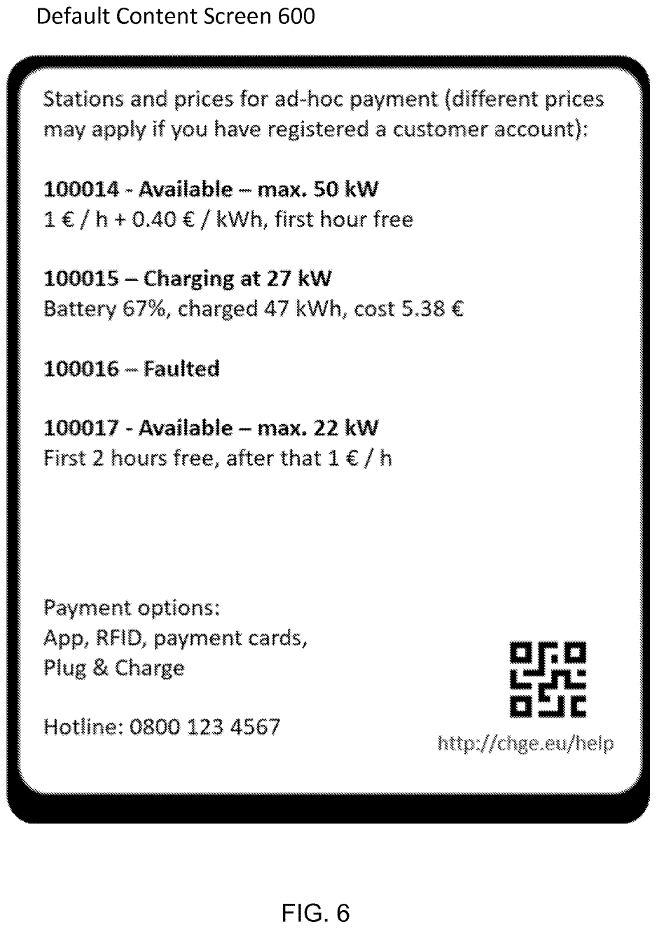

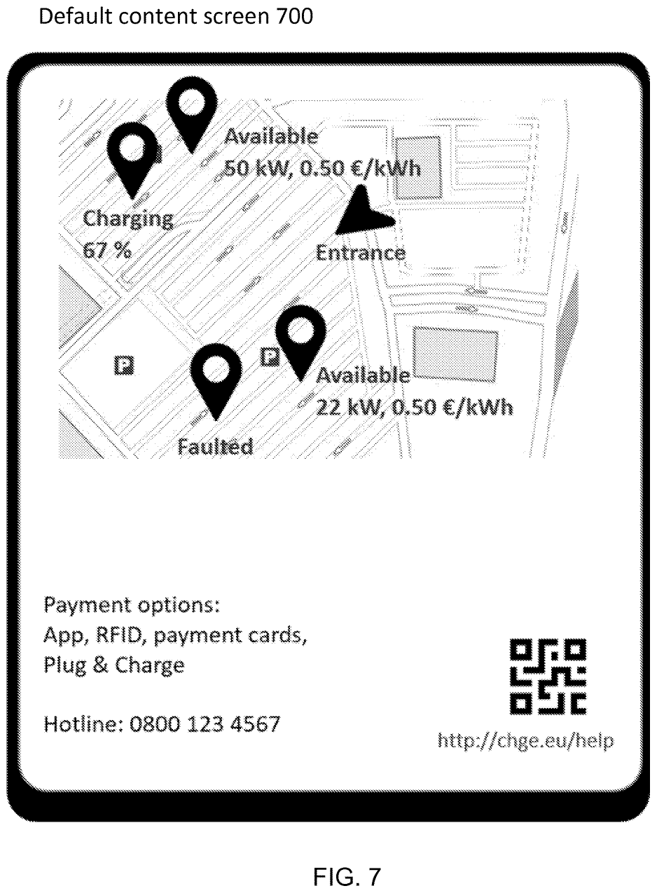

In another embodiment of the disclosure, a default content screen 600, 700 is a behavior of the embodiment, where general information of multiple charging stations 203 may be conveyed at the same time, such as in FIG. 6 or in FIG. 7. FIG. 6 illustrates the screen device 202 displaying information of four different CS's (identified as 100014-100017) on a theoretical EV 205 charging site 299 through the data link's 411 and 412. A portion of information of each of these CS's 203 is listed on the screen device (202), such as the current status for charging (availability, error message etc.) or rates for separate EMP contracts. Additional information may be configured by the administrator to be shown such as payment options. FIG. 7. illustrates another option for the administrator to configure, where a charging site 299 map shows a location of each CS 203 installed on the site and a portion of their status information.

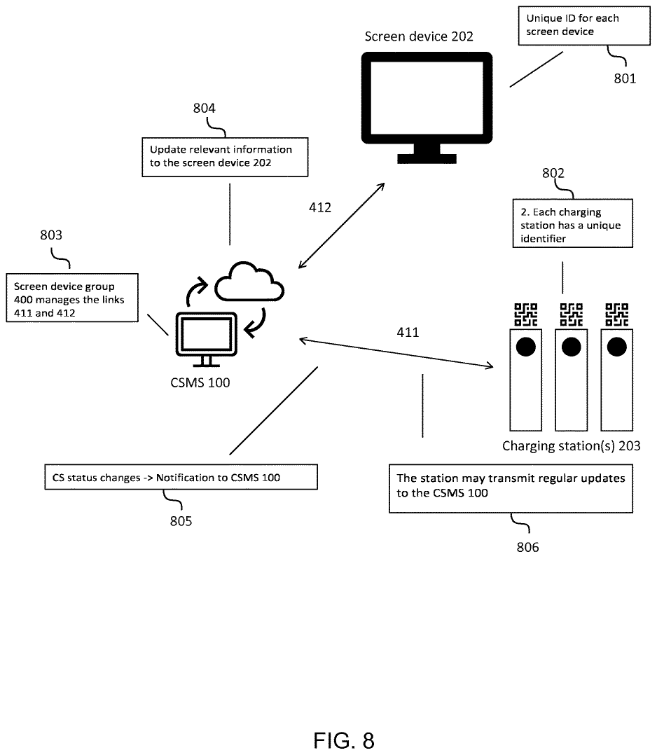

The embodiment of the technical solution for configuring the default content screens of FIG. 6 and FIG. 7 is illustrated in FIG. 8. In this embodiment, the screen device 202 comprises a unique identifier as illustrated in 801 and each charging station comprises a unique identifier (QRID) as illustrated in 802. The screen device group 400 manages these identifiers as illustrated in 803. Any updates made to the CSMS 100 database 300, such as prices or service messages, are then transmitted to the screen device 202 through the data link 412 as illustrated in 804. When a status of a CS 203 changes, the CS 203 may send a notification to the CSMS 100, the notification comprising the new status. The CSMS 100 then verifies, with the screen device group 400, if that CS 203 belong to any screen device 202 and updates the data link 412 as illustrated in 805. The CSMS 100 further receives regular updates from the CS 203 during a charging event, such as kWh usage, and calculates the running charging cost that is updated on the screen device(s) associated with the CS 203. Furthermore, a CS 203 may send a status change message through the data link 311 to the CSMS 100 as illustrated in 806.

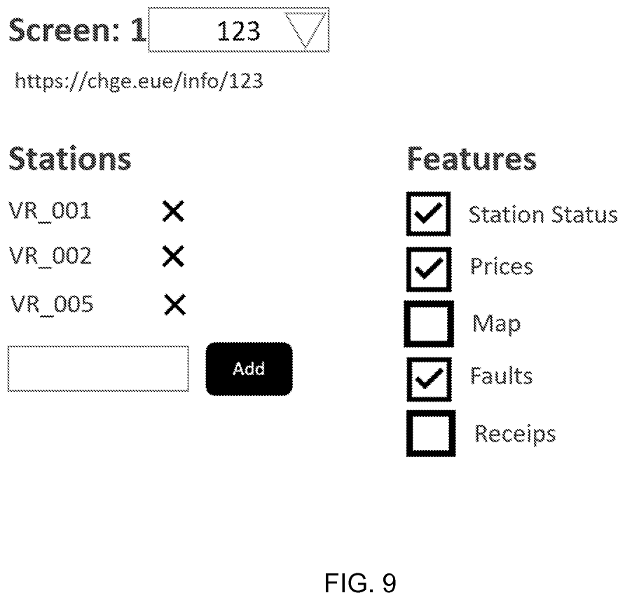

FIG. 9. illustrates an example embodiment of a menu configuration screen on a screen device 202, where an administrator may configure the screen device group 400. Each screen device 202 may be connected to obtain data from multiple stations at the same time, such as in the case of the default content screens 600 and 700, or multiple screen devices 202 may be set to obtain data only from a singular CS 203.

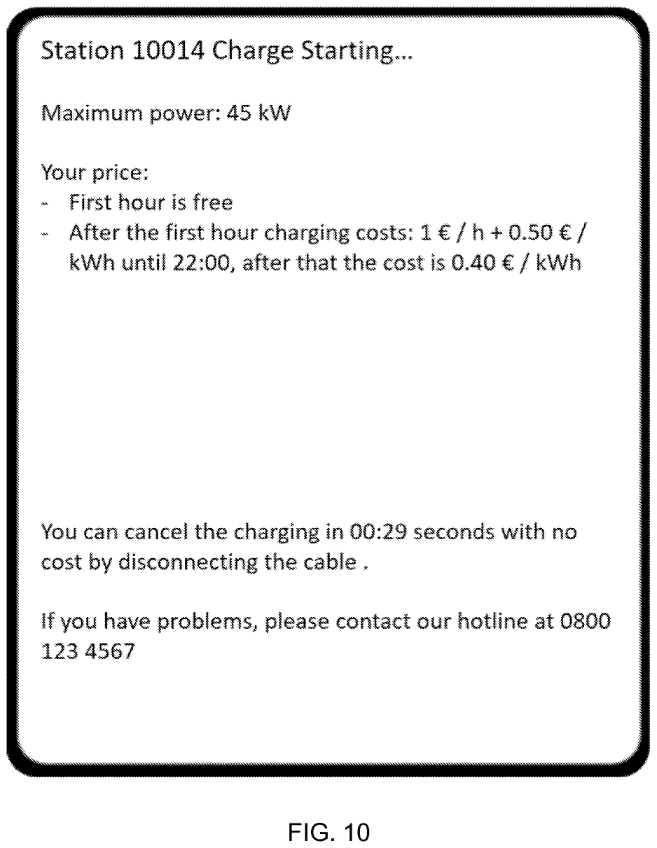

When an end-user 206 starts a new charging event, the screen device 202 may display information related to the beginning of the charging event, such as available maximum power, upcoming charging rate changes or reservations and additional information such as possibility to cancel the charging event as illustrated in FIG. 10.

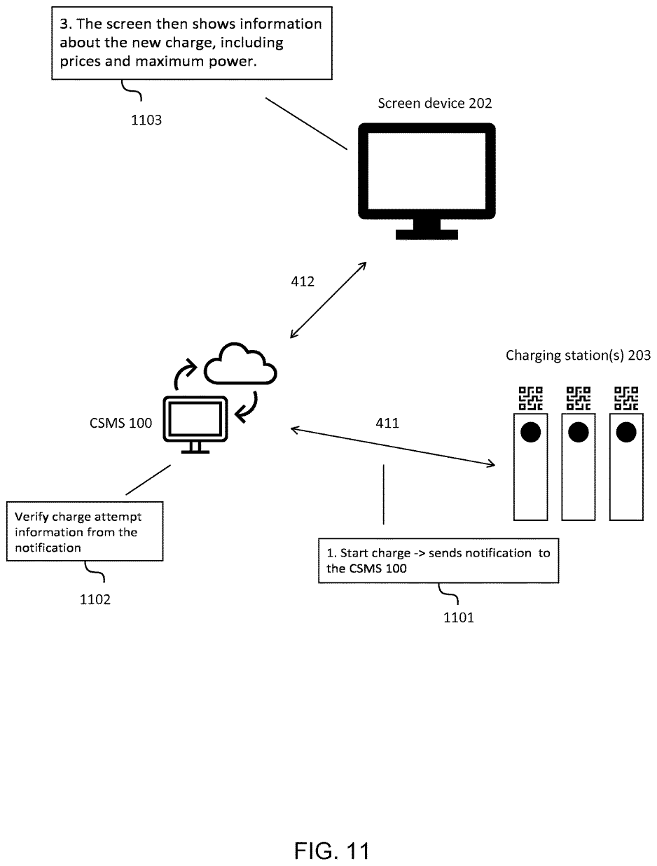

The technical solution for starting the new charge is illustrated in FIG. 11. As the end-user 206 starts a new charging event, the CS 203 may send a charge attempt notification to the CSMS 100. The charge attempt notification comprises a unique identifier, such as an RFID card number or an ISO15118 Plug & Charge contract identifier as illustrated in 1101. The CSMS 100 may use this charge attempt notification to recognize the contract information of the end-user 206 as illustrated in 1102. Along with the information from the initial charge attempt notification, additional information may be transmitted to the screen device 202 as illustrated in 1103.

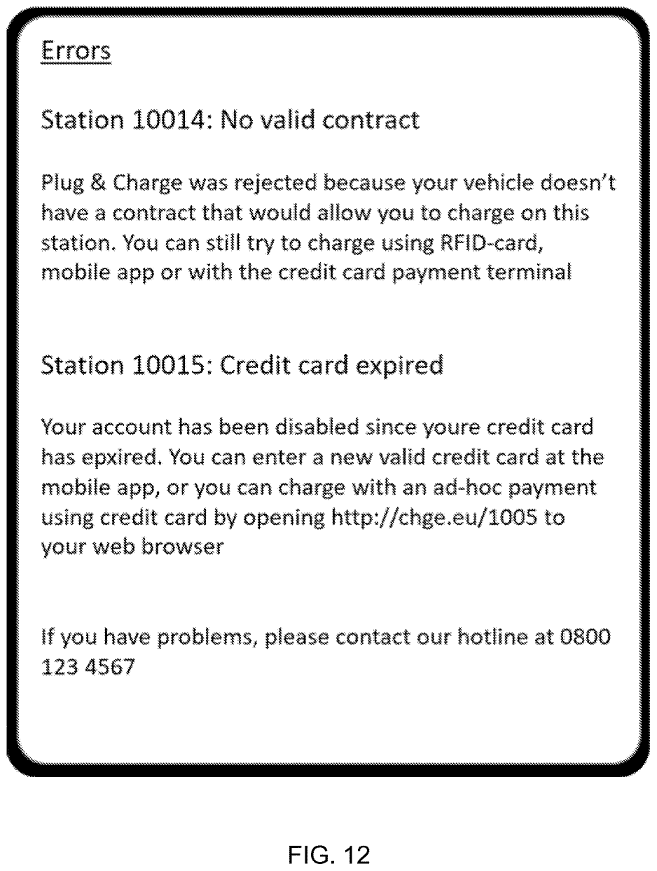

A rejection of a charging event may be caused by non-valid ISO15118 Plug & Charge contract, or an expired credit card etc. FIG. 12 illustrates an embodiment how a screen device 202 is configured to display a charge rejection message.

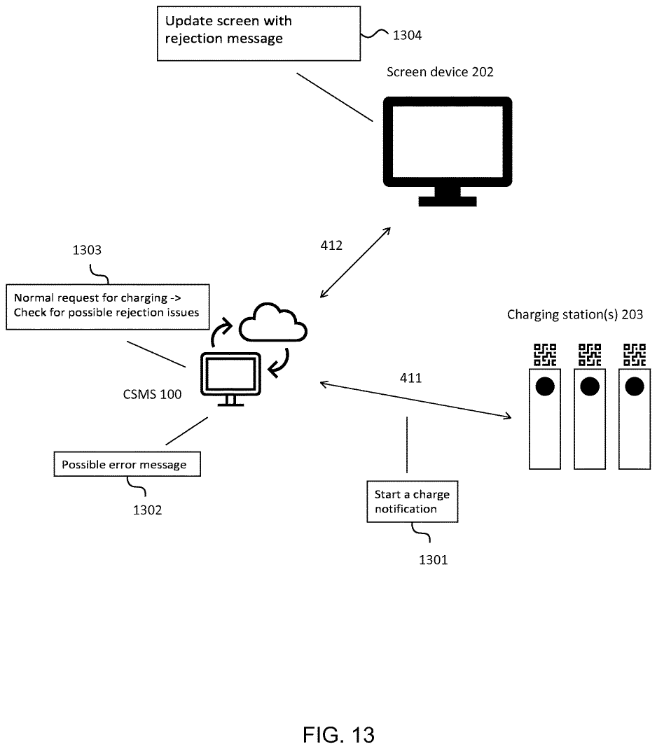

FIG. 13 illustrates the technical solution for the rejection of a charge event. First, an end-user 206 may start a charge in a CS 203 and the CS 203 sends a notification to the CSMS 100, which may contain an error message, as illustrated in 1301. The CSMS 100 may handle that possible error message, as illustrated by 1302, or in other case it may get a normal request to start charging as illustrated in 1303. If the end-user 206 is not allowed to charge, the CSMS 100 executes two functions: i) A “rejected” answer goes back to the CS 203 and ii) the screen device 202 linked to the CSMS 100 is updated displaying the reason for the rejection as illustrated in 1304.

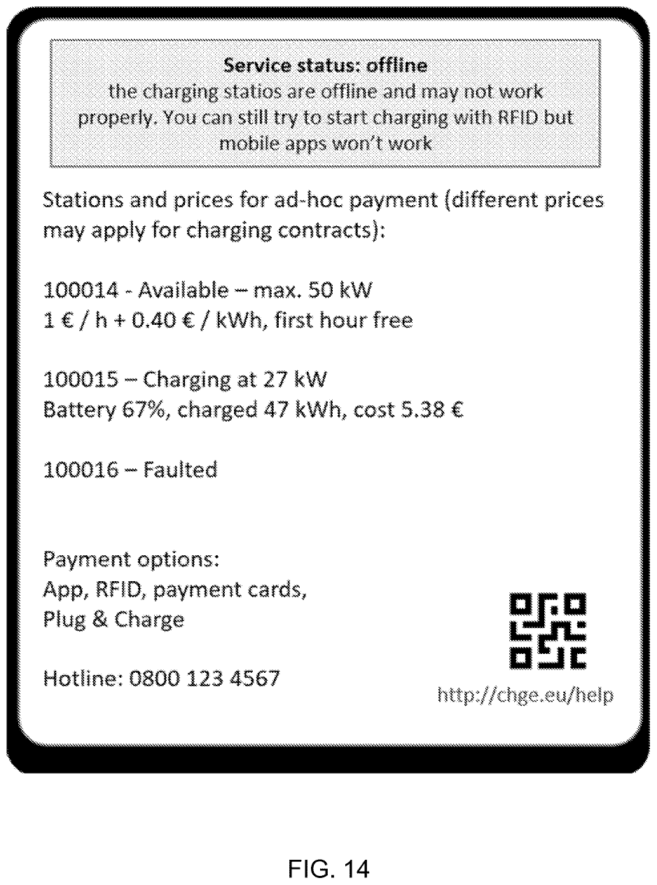

FIG. 14 illustrates an example embodiment, where a screen device 202 displays a service status message, where the message conveys the offline status of all the stations and a possible solution.

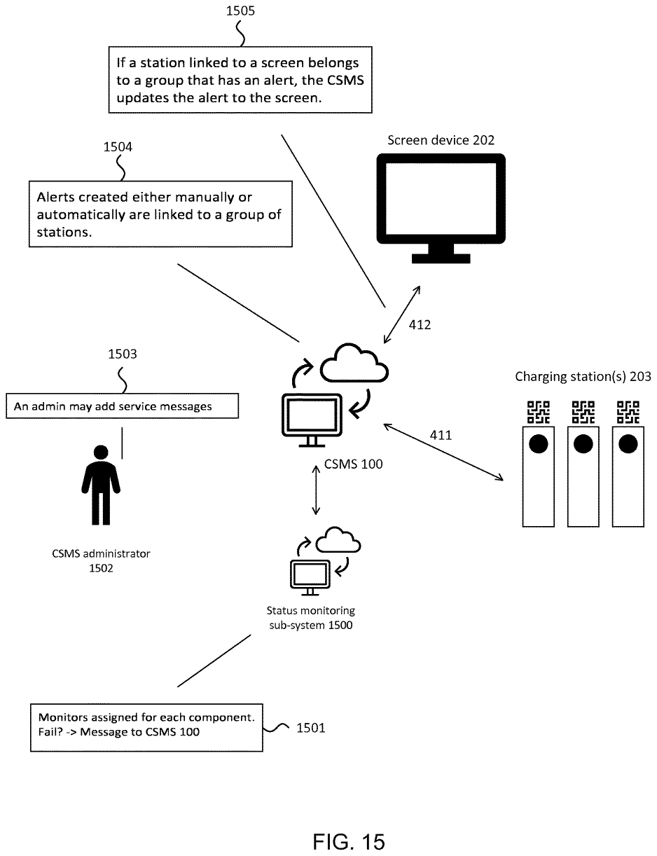

In FIG. 15 a technical solution for monitoring the status of the CS 203 and the CSMS 100 is illustrated. A status monitoring sub-system 1500 monitors the status of different components linked to the CSMS 100, such as the CS's 203. The status monitoring sub-system may send an alert to the CSMS 100 if one these monitors fail as illustrated in 1501. Additionally, a CSMS administrator 1502 may also add service status information to the CSMS 100 and the status monitoring sub-system 1500, such as problems discovered by calls to a hotline, as illustrated in 1503. Any alert created manually or automatically are linked to a group of CS's 203 as is illustrated in 1504. Should a CS 203 be linked to a screen device 202, the CSMS 100 updates that alert to the screen device 202 as illustrated in 1505.

When a charging event has ended, the screen device 202 may be updated by the CSMS 100. FIG. 15. illustrates an example embodiment of the screen device 202 displaying information of the charging event, such as duration, total energy charged and total cost of the event. Additional information such as receipt availability may be displayed as well.

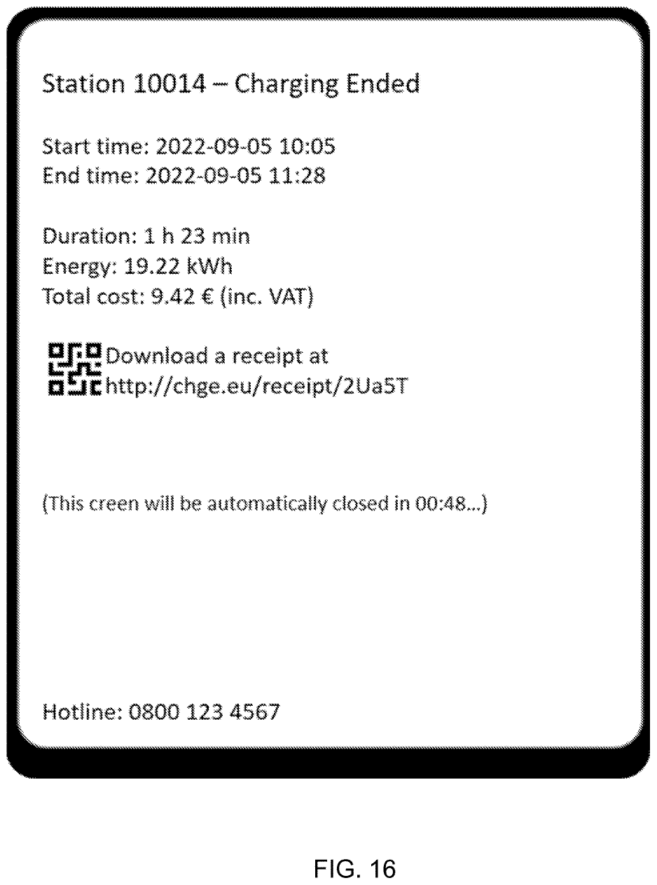

FIG. 16 illustrates the technical solution for conveying the ending of a charge event information on the screen device 202. The CS 203 sends a charging event end message to the CSMS 100, which also comprises of additional information such as total duration of the charging event and used energy as illustrated in 1701. The CSMS 100 comprises algorithms that can calculate the total final cost of the charge event, which is then updated, along with the additional information, to the screen device 202 as illustrated in 1702.

When the device 100 is configured to implement some functionality, some component and/or components of the device 100, such as the at least one processor 101 and/or the memory 102, may be configured to implement this functionality. Furthermore, when the at least one processor 101 is configured to implement some functionality, this functionality may be implemented using program code 103 comprised, for example, in the memory 102. For example, if the simulator device 100 is configured to perform an operation, the at least one memory 102 and the computer program code 103 can be configured, with the at least one processor 101, to cause the network node device 100 to perform that operation.

A device 100 may comprise means for performing any aspect of the method(s) described herein. According to an example embodiment, the means comprises at least one processor, and memory comprising program code, the at least one processor, and program code configured, when executed by the at least one processor, to cause performance of any aspect of the method.

The functionality described herein can be performed, at least in part, by one or more computer program product 103 components such as software components. According to an example embodiment, the device 100 comprises a processor 101 configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), Application-specific Integrated Circuits (ASICs), Application-specific Standard Products (ASSPs), System-on-a-chip systems (SOCs), Complex Programmable Logic Devices (CPLDs), and Graphics Processing Units (GPUS).

Any range or device value given herein may be extended or altered without losing the effect sought. Also, any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

1. A device for operating an electric vehicle charging station management system, comprising:
at least one processor; and
at least one memory including programmable logic;
the at least one memory and the programmable logic configured to, when executed by the at least one processor, cause the device to:
obtain an identification of a screen device;
store at least one identification of a charging station, QRID, wherein the at least one QRID is associated with two or more charging stations;
associate the screen device with the QRID;
receive a first request from a client device, wherein the first request comprises a request to receive an authorization to receive further data from the client device and wherein the client device is a device capable of scanning the QR-code;
generate the authorization, the authorization comprising code for the client device to generate a certificate;
transmit the authorization to the client device;
receive the certificate from a client device wherein the certificate comprises the QRID;
based on the QRID, transmit a second request to the identified two or more charging stations connected to the device and based on the second request, receive a first data from the two or more charging stations, the first data comprising information of the two or more charging stations; and
based on the first data and the certificate, transmit a second data to the screen device identified in the certificate and associated with the QRID, the second data comprising at least a portion of the first data to be displayed on the screen device.

2. The device according to claim 1, wherein the received first data further comprises running charging cost of a charging event.

3. (canceled)

4. The device according to claim 1, wherein the device further comprises a database and the device is further configured to:
store the at least one QRID; and
store the identification of the screen device.

5. The device according to claim 4, where the device further comprises an infoscreen logic wherein the infoscreen logic is configured to:
decide the contents of the second data to be displayed on the screen device; and
obtain at least a portion of the second data from the database.

6. The device according to claim 5, wherein the device further comprises a web server, and wherein the web server is configured to:
receive the first request from a client device;
transmit the authorization;
receive the certificate; and
transmit the second data.

7. The device according to claim 6, where the device further comprises an application programming interface, API, wherein the API is configured to:
transmit the second request to the charging station;
receive the first data; and
direct the first data to the database.

8. The device according to claim 1, where the device is further configured to:
control a screen device group wherein the screen device group comprises:
a first data link 411 to at least one charging station associated with the at least one QRID;
a second data link 412 to at least one screen device; and
a third data link 413 to the device;

9. The device of claim 8, wherein the second data link further comprises a data link to a plurality of screen devices.

10. A system for displaying status information related to a charging operation of an electric vehicle, EV, wherein said system comprises:
the device according to claim 1;
at least one screen device configured to receive the second data from the device and configured to display at least a portion of the said second data; and
at least one client device configured to: scan the QR-code;
based on the QR-code, transmit the first request to the device to obtain the authorization; and
based on the authorization, transmit a certificate to the device;

11. A system according to claim 10, where the at least one screen device comprises at least a portion of the at least one client device.

12. A method for operating an electric vehicle charging station management system device, the method comprising:
obtaining at least one identification of a screen device;
storing at least one identification of a charging station, QRID, wherein the at least one QRID is associated with two or more charging stations;
associating the screen device with the QRID;
receiving (210a) a first request from a client device, wherein the first request comprises a request to receive an authorization to receive further data from the client device and wherein the client device is a device capable of scanning the QR-code;
generating the authorization, the authorization comprising code for the client device to generate a certificate;
transmitting the authorization to the client device;
receiving the certificate from a client device, wherein the certificate comprises the QRID;
based on the QRID, transmitting a second request to the identified two or more charging stations connected to the device and based on the second request, receiving a first data from the charging station, the first data comprising information of the two or more charging stations; and
based on the first data and the certificate, transmitting a second data to the screen device identified in the certificate and associated with the QRID, the second data comprising at least a portion of the first data to be displayed on the screen device.

13. (canceled)

14. The method of claim 12, further comprising a screen device group, the screen device group comprising:
a first data link 411 to at least one charging station associated with the QRID; and
a second data link 412 to at least one screen device

15. A computer program product comprising program code configured to perform the method according to claim 12 when the computer program product is executed on a computer.
